(19) United States
(12) Patent Application Publication
(10) Pub. No.: US 2023/0074916 A1
(43) Pub. Date: Mar. 9, 2023

(54) RUTILE-TYPE TITANIUM OXIDE ORGANOSOL, METHOD FOR PRODUCING RUTILE-TYPE TITANIUM OXIDE ORGANOSOL, HIGH REFRACTIVE INDEX COATING-FORMING COMPOSITION USING SAID RUTILE-TYPE TITANIUM OXIDE ORGANOSOL, AND OPTICAL ELEMENT

(71) Applicant: TAYCA CORPORATION, Osaka-shi, Osaka (JP)

(72) Inventors: Ryouhei Mishima, Osaka-shi (JP); Nobuyuki Yokoyama, Osaka-shi (JP)

(73) Assignee: TAYCA CORPORATION, Osaka-shi, Osaka (JP)

(21) Appl. No.: 17/798,656

(22) PCT Filed: Mar. 17, 2021
(86) PCT No.: PCT/JP2021/010719

§ 371 Date: Aug. 10, 2022

(30) Foreign Application Priority Data
Mar. 26, 2020 (JP) 2020-055315
Oct. 23, 2020 (JP) 2020-177781

(51) Int. Cl. C09D 17/00; C09C 1/36; C09D 7/45; C09D 7/20; C09D 7/63; C09D 7/62; C09D 175/14; G02B 1/14; G02B 1/111

(52) U.S. Cl. CPC C09D 17/002; C09C 1/3684; C09D 7/20; C09D 7/45; C09D 7/62; C09D 7/63; C09D 17/008; C09D 175/14; G02B 1/14; G02B 1/111

(57) ABSTRACT

There has been demand for a titanium oxide organosol that has a high transparency and a high refractive index and that also exhibits an excellent viscosity stability over time. The rutile-type titanium oxide organosol according to the present invention comprises a silane coupling agent, a basic additive acting as a deflocculant, a water-insoluble solvent, and rutile-type titanium oxide particles that have been surface-treated with a hydrous oxide of at least one metal species selected from Zr, Ce, Sn, and Fe, the rutile-type titanium oxide organosol being characterized in that the Ti ratio contained in the colloidal particles in the rutile-type titanium oxide organosol is at least 60 mass% when calculated as the oxide, and the ratio of metal species at the colloidal particle surface derived from x-ray photoelectron spectroscopy is 20-50 mass%.

### TECHNICAL FIELD

The present invention relates to an organosol in which rutile-type titanium oxide is dispersed in a water-insoluble solvent and a method for producing the titanium oxide organosol. More specifically, the present invention relates to an organosol that has a high transparency and a high refractive index and a method for producing the titanium oxide organosol.

The present invention further relates to a high refractive index coating-forming composition using the rutile-type titanium oxide organosol and an optical element.

### BACKGROUND ART

To date, titanium oxide organosols in which titanium oxide is dispersed in a water-insoluble solvent have been used as, for example, coating agents for adjusting the refractive index to make antireflection films for optical components, and various types of titanium oxide organosols have been developed (Patent Literatures 1 to 3).

Specifically, Patent Literature 1 discloses an organosol obtained by preparing a hydrosol in the co-presence of a tin compound, and subsequently performing solvent substitution. Patent Literature 2 discloses an organosol obtained by treating the surface of titanium oxide with a silane coupling agent and 12-hydroxystearic acid, and subsequently performing solvent substitution. Patent Literature 3 discloses an organosol obtained by treating the surface of titanium oxide with a silane coupling agent having a specific structural formula, and subsequently performing solvent substitution.

### Citation List

### Patent Literature

PTL 1: International Publication No. WO 2006/1487

PTL 2: International Publication No. WO 2016/136763

PTL 3: Japanese Unexamined Patent Application Publication No. 2017-178736

### SUMMARY OF INVENTION

### Technical Problem

Such a titanium oxide organosol is required to have a transparency and a viscosity stability over time in the form of a sol and required to also have a high refractive index from the viewpoint that a reduction in the film thickness and the size of an optical element can be achieved when formed into a coating layer.

There are two types of titanium oxide, that is, anatase-type and rutile-type titanium oxides, and rutile-type titanium oxide has a feature that it has a higher refractive index than anatase-type titanium oxide. In addition, rutile-type titanium oxide is characterized by having a lower photocatalytic activity than anatase-type titanium oxide and thus has a feature that, when rutile-type titanium oxide is used as a raw material, degradation and discoloration of an organic material or the like due to the photocatalytic activity are less likely to be generated.

Accordingly, there has been a demand for an organosol that exhibits a high transparency and a high refractive index due to the use of rutile-type titanium oxide and that further exhibits an excellent viscosity stability over time. However, titanium oxide particles exhibit a good dispersibility in aqueous solvents but exhibit a low dispersibility in water-insoluble solvents, and thus currently, in organosols, it is difficult to meet all such requirements at high levels.

Recently, as a result of extensive studies, the inventors of the present application have found that a titanium oxide organosol that has a high transparency and a high refractive index in a water-insoluble solvent can be obtained by treating the surface of rutile-type titanium oxide with a hydrous oxide of a specific metal species so as to have a specific surface ratio, and deflocculating rutile-type titanium oxide particles that have been subjected to the surface treatment in the presence of a silane coupling agent and a basic additive. Moreover, it has been found that the titanium oxide organosol also has an excellent characteristic in the viscosity stability over time while containing titanium oxide particles at a high concentration.

The present invention has been made in view of the known problems described above, and an object of the present invention is to provide a rutile-type titanium oxide organosol that has a high transparency and a high refractive index and that also exhibits an excellent viscosity stability over time.

### Solution to Problem

To achieve the above object, a rutile-type titanium oxide organosol according to the present invention contains rutile-type titanium oxide particles that have been surface-treated with a hydrous oxide of at least one metal species selected from Zr, Ce, Sn, and Fe, a silane coupling agent, a basic additive acting as a deflocculant, and a water-insoluble solvent, the rutile-type titanium oxide organosol being characterized in that a ratio of Ti contained in colloidal particles in the rutile-type titanium oxide organosol is at least 60 mass% when calculated as the oxide, and a ratio of the metal species at surfaces of the colloidal particles derived from x-ray photoelectron spectroscopy is 20 to 50 mass%.

The rutile-type titanium oxide organosol according to the present invention is characterized in that a content ratio of the colloidal particles is at least 28 mass% when calculated as the oxide, and a viscosity is 15 mPa·s or less.

The rutile-type titanium oxide organosol according to the present invention is characterized by having a haze value of 20% or less measured at an optical path length of 10 mm when being diluted with the water-insoluble solvent to a solid content of 5% by mass.

The rutile-type titanium oxide organosol according to the present invention is characterized in that the basic additive is a water-soluble amine.

A high refractive index coating-forming composition according to the present invention is characterized by containing the rutile-type titanium oxide organosol according to the present invention.

An optical element according to the present invention is characterized by including the high refractive index coating-forming composition according to the present invention.

The optical element according to the present invention is characterized in that the coating layer has a pencil hardness of at least 6 H.

A method for producing a rutile-type titanium oxide organosol according to the present invention is characterized by including a step of producing a hydrosol of rutile-type titanium oxide, a step of treating a surface of the rutile-type titanium oxide with a hydrous oxide of at least one metal species selected from Zr, Ce, Sn, and Fe, a step of subjecting the hydrosol of the surface-treated rutile-type titanium oxide to solvent substitution with a water-insoluble solvent to prepare an organosuspension, and a step of adding a basic additive and a silane coupling agent to the organosuspension to form an organosol.

The method for producing a rutile-type titanium oxide organosol according to the present invention is characterized by further including a hydrothermal treatment step.

### Advantageous Effects of Invention

According to the present invention, first, a hydrous oxide of metal species having a high refractive index, such as Zr, Ce, Sn, and Fe is used to cover the surface of rutile-type titanium oxide such that the hydrous oxide of the metal species has a specific surface ratio, and therefore, colloidal particles that exhibit a high refractive index can be obtained. In addition, since the Ti ratio in the colloidal particles is within a specific range, it is possible to obtain colloidal particles that exhibit a high refractive index while maintaining a high transparency. Furthermore, since the surface-treated rutile-type titanium oxide particles are deflocculated (dispersed) in the presence of a silane coupling agent and a basic additive, an organosol that has a low viscosity in a water-insoluble solvent and that exhibits an excellent viscosity stability over time can be obtained.

In addition, since an organosol is provided, good compatibility with water-insoluble resins can also be achieved.

According to the rutile-type titanium oxide organosol according to the present invention, the use of a water-soluble amine as the basic additive enables the surface-treated rutile-type titanium oxide particles to be effectively deflocculated (dispersed) in a water-insoluble solvent.

According to the high refractive index coating-forming composition and the optical element according to the present invention, since the rutile-type titanium oxide organosol of the present invention is used, a coating that exhibits a high refractive index and a high hardness can be formed while maintaining a high transparency, and a reduction in the film thickness and the size of the optical element can be achieved.

### DESCRIPTION OF EMBODIMENTS

Embodiments of the present invention will be described on the basis of the drawings. Note that the embodiments described below are merely examples that embody the present invention and do not limit the technical scope of the present invention.

### Basic Configuration

First, a basic configuration of a rutile-type titanium oxide organosol according to the present invention will be described.

The rutile-type titanium oxide organosol according to the present invention has a basic configuration that includes, as main components, rutile-type titanium oxide particles that have been surface-treated with a hydrous oxide of at least one metal species selected from Zr, Ce, Sn, and Fe, a silane coupling agent, a basic additive, and a water-insoluble solvent.

In the rutile-type titanium oxide organosol according to the present invention, since rutile-type titanium oxide is used and the surface of the rutile-type titanium oxide is treated with a hydrous oxide of metal species having a high refractive index, such as Zr, Ce, Sn, and Fe, in this manner, colloidal particles whose photocatalytic activity can be suppressed and which exhibit a high refractive index can be obtained. In addition, since the surface-treated rutile-type titanium oxide particles are deflocculated in the presence of the silane coupling agent and the basic additive, an organosol that exhibits an excellent viscosity stability over time can be obtained.

The content ratio of the colloidal particles in the rutile-type titanium oxide organosol according to the present invention is appropriately determined according to the desired degree of transparency and refractive index. In order to obtain a highly-refractive coating film, the rutile-type titanium oxide organosol preferably contains the colloidal particles in an amount of at least 28 mass% when calculated as the oxide. Incidentally, the upper limit of the content ratio is not particularly limited but is preferably 60 mass% or less when calculated as the oxide in view of the viscosity. Of these, the content ratio is more preferably 29 to 45 mass% when calculated as the oxide.

The phrase “when calculated as the oxide” as used herein means a case where target inorganic components (in the above case, inorganic components (a Ti component in titanium oxide, a metal component in the hydrous oxide of the metal species, and a Si component in the silane coupling agent) in the organosol) are calculated as oxides.

Specifically, for example, in the rutile-type titanium oxide organosol described above, the content ratio when calculated as the oxide is a value determined by the following formula when the rutile-type titanium oxide organosol is heated at 925° C. for two hours.

Content ratio when calculated as the oxide (%) = (mass of rutile-type titanium oxide organosol after heating/mass of rutile-type titanium oxide organosol before heating) × 100

The viscosity of the rutile-type titanium oxide organosol according to the present invention is also appropriately determined according to the desired degree of transparency and refractive index as in the content ratio of the colloidal particles and is preferably 15 mPa·s or less at 25° C.

The rutile-type titanium oxide organosol according to the present invention exhibits a high transparency because the colloidal particles are uniformly and stably dispersed. Specifically, a haze value is 20% or less as measured at an optical path length of 10 mm after dilution with the water-insoluble solvent to a solid content of 5% by mass.

### Colloidal Particles

Rutile-type titanium oxide particles used in the present invention are rutile-type titanium oxide particles serving as colloidal particles and having surfaces that have been surface-treated with a hydrous oxide of at least one metal species selected from Zr, Ce, Sn, and Fe, as described above, and the ratio of the metal species at the colloidal particle surfaces is required to be 20 to 50 mass% in x-ray photoelectron spectroscopy. In addition to this surface ratio, the ratio of Ti contained in the colloidal particles is also required to be at least 60 mass% when calculated as the oxide.

That is, for the rutile-type titanium oxide organosol according to the present invention, it is necessary to use colloidal particles in which titanium that is a main component is present in at least a certain amount, and the hydrous oxide of the metal species is present at the surfaces in a ratio within a specific range. By meeting this requirement, colloidal particles whose photocatalytic activity can be suppressed and which exhibit a high transparency and a high refractive index in the water-insoluble solvent can be obtained.

Here, x-ray photoelectron spectroscopy is an analysis method also called ESCA or XPS, is an analysis method for conducting qualitative/quantitative analysis of elements by analyzing photoelectrons emitted by irradiating a sample with x-rays, and is widely used as an analysis method of elements present in a surface layer portion (a depth of about 5 nm) of a sample because soft x-rays are applied. In the present invention, the ratio of the metal species at the colloidal particle surfaces is required to be 20 to 50 mass% (more preferably 30 to 40 mass%) in the x-ray photoelectron spectroscopy.

If the ratio of the metal species at the colloidal particle surfaces is less than 20 mass% or exceeds 50 mass%, dispersion stability of the rutile-type titanium oxide organosol decreases, which may cause, for example, gelation.

The ratio of Ti contained in the colloidal particles is 60 to 99 mass% when calculated as the oxide (TiO₂) and is preferably 60 to 90 mass% (more preferably 85 to 90 mass%) in view of the ratio of the metal species at the colloidal particle surfaces.

### Silane Coupling Agent

The silane coupling agent used in the present invention stably deflocculates the surface-treated rutile-type titanium oxide particles in the water-insoluble solvent together with the basic additive described later and provides an organosol that exhibits an excellent viscosity stability over time.

In this manner, the rutile-type titanium oxide organosol according to the present invention is obtained by forming rutile-type titanium oxide into titanium oxide particles having a specific surface form, and deflocculating the titanium oxide particles with specific materials, i.e., the silane coupling agent and the basic additive, and thus the organosol can satisfy all the transparency, refractive index, viscosity stability over time, and compatibility with water-insoluble resins.

Publicly known silane coupling agents can be used, and examples thereof include vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, p-styryltrimethoxysilane, 3-acryloxypropyltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, tris-(trimethoxysilylpropyl)isocyanurate, 3-ureidopropyltrialkoxysilane, 3-mercaptopropylmethyldimethoxysilane, and 3-mercaptopropyltrimethoxysilane. From the viewpoint that a rutile-type titanium oxide organosol having a low viscosity can be prepared, of these, silane coupling agents having an acryloxy group or a methacryloxy group are preferably used, and furthermore, of these, 3-acryloxypropyltrimethoxysilane and 3-methacryloxypropyltrimethoxysilane are preferably used.

The content of the silane coupling agent is not particularly limited, and is preferably 3 to 60 mass% relative to titanium (TiO₂), in particular, preferably 5 to 40 mass% relative to TiO₂, and, in particular, preferably 20 to 35 mass% relative to TiO₂. At a content of less than 3 mass%, solation may be unlikely to occur. At a content of more than 60 mass%, the refractive index of the resulting coating may decrease.

### Basic Additive

The basic additive used in the present invention stably deflocculates the surface-treated rutile-type titanium oxide particles in the water-insoluble solvent together with the silane coupling agent and provides an organosol that exhibits an excellent viscosity stability over time.

Herein, the basic additive may be any basic material, and sodium hydroxide, aqueous ammonia, or the like may also be used. From the viewpoint that a stable deflocculation property (dispersibility) can be exhibited, a water-soluble amine is preferably used. Although the mechanism with which a water-soluble amine exhibits a stable deflocculation property (dispersibility) is unclear, the surface-treated rutile-type titanium oxide particles used in the present invention can be deflocculated in the “water-insoluble” solvent at a high concentration by using not a “water-insoluble” amine but a “water-soluble” amine in spite of providing an organosol and by combining the water-soluble amine and the silane coupling agent.

Examples of the water-soluble amine include water-soluble alkylamines such as tert-butylamine, isopropylamine, diisopropylamine, diethylamine, propylamine, n-butylamine, and isobutylamine; water-soluble alkanolamines such as triethanolamine, diethanolamine, N-methylethanolamine, and 2-amino-2-methyl-1-propanol; heterocyclic amines such as pyridine; and amine-based dispersants such as DISPERBYK-108, DISPERBYK-109, and DISPERBYK-180 (manufactured by BYK Japan KK) . Of these, tert-butylamine and DISPERBYK-108 are preferably used from the viewpoint that a rutile-type titanium oxide organosol having a low viscosity can be prepared.

The content of the basic additive is not particularly limited, and is preferably 0.5 to 30 mass% relative to titanium (TiO₂), and in particular, preferably 1 to 20 mass% relative to TiO₂. At a content of less than 0.5 mass%, solation may be unlikely to occur. At a content of more than 30 mass%, when a high refractive index coating-forming composition described later is prepared, for example, a problem may occur in which the basic additive causes a reaction with a binder in the high refractive index coating-forming composition and gelates.

### Water-Insoluble Solvent

The water-insoluble solvent used in the present invention is a water-insoluble solvent having a solubility parameter (SP value, Fedors method) of less than 10. Various water-insoluble solvents can be used, such as acetates, e.g., ethylene glycol monomethyl ether acetate, diethylene glycol monobutyl ether acetate, diethylene glycol monoethyl ether acetate, cyclohexanol acetate, propylene glycol diacetate, and propylene glycol monomethyl ether acetate; esters, e.g., ethyl acetate, methyl acetate, ethyl acetate, butyl acetate, and methoxybutyl acetate; ketones, e.g., methyl ethyl ketone, methyl isobutyl ketone, methyl isopropyl ketone, methyl amyl ketone, and cyclohexanone; and aromatic hydrocarbons, e.g., toluene and xylene. Of these, acetates such as propylene glycol monomethyl ether acetate are preferably used.

### High Refractive Index Coating-Forming Composition

A high refractive index coating-forming composition according to the present invention contains the rutile-type titanium oxide organosol according to the present invention and therefore, can form a coating having a high transparency and a high refractive index without adversely affecting a substrate.

In the high refractive index coating-forming composition according to the present invention, a resin mixed with the rutile-type titanium oxide organosol according to the present invention may be, for example, a thermosetting resin, a thermoplastic resin, or a UV-curable resin, and in particular, a UV-curable resin is preferably used. Examples of the UV-curable resin include monofunctional and bifunctional crosslinkable monomers such as benzyl (meth)acrylate, phenoxyethyl (meth)acrylate, isoamyl (meth)acrylate, isobornyl (meth)acrylate, 2-hydroxy-3-phenoxypropyl (meth)acrylate, ethylene glycol di(meth)acrylate, propylene glycol di(meth)acrylate, hexanediol di(meth)acrylate, neopentyl glycol di(meth)acrylate, and triethylene glycol di(meth)acrylate; and polyfunctional crosslinkable monomers such as trimethylolpropane tri(meth)acrylate, pentaerythritol tetra(meth)acrylate, pentaerythritol tri(meth)acrylate, dipentaerythritol penta(meth)acrylate, dipentaerythritol hexa(meth)acrylate, and isocyanuric acid tris[ethyloxy (meth)acrylate] . These monofunctional, bifunctional, and polyfunctional crosslinkable monomers may be used alone or as a mixture of two or more thereof.

The content of the rutile-type titanium oxide organosol according to the present invention in the high refractive index coating-forming composition according to the present invention is appropriately determined according to the desired refractive index and is preferably 30 to 80 mass% in order to form a coating having a high refractive index.

### Polymerization Initiator

In the preparation of the high refractive index coating-forming composition according to the present invention, a polymerization initiator is used according to the type of resin mixed with the rutile-type titanium oxide organosol according to the present invention. The type of polymerization initiator is not particularly limited, and publicly known polymerization initiators may be used. Examples of the type of polymerization initiator include radical initiators, ionic polymerization initiators, and photopolymerization initiators. When a UV-curable resin is used as the resin, a photopolymerization initiator is preferably used. Specifically, examples of radical initiators include azoisobutyronitrile, 1,1'-azobis(cyclohexanecarbonitrile), di-tert-butylperoxide, tert-butylhydroperoxide, and benzoyl peroxide, and examples of photopolymerization initiators include 1-hydroxycyclohexylphenyl ketone, bis(2,4,6-trimethylbenzoyl)-phenylphosphine oxide, 3-hydroxybenzophenone, 2,2-dimethoxy-2-phenylacetophenone, 2-methyl-l-[4-(methylthio)phenyl]-2-morpholinopropan-1-one, monoacylphosphine oxide, 4,4'-bis(dimethylamino)benzophenone, and 2,4-diethylthioxanthone. These polymerization initiators may be used alone or as a mixture of two or more thereof.

### Optical Element

An optical element according to the present invention has a coating layer formed from the high refractive index coating-forming composition according to the present invention; therefore, an optical element that has a coating with a high refractive index despite a small thickness thereof can be obtained, and a reduction in the film thickness and the size of the optical element can be achieved.

### Production Method

A method for producing a rutile-type titanium oxide organosol according to the present invention includes (1) a step of producing a hydrosol of rutile-type titanium oxide, (2) a step of treating a surface of the rutile-type titanium oxide with a hydrous oxide of at least one metal species selected from Zr, Ce, Sn, and Fe, (3) a step of subjecting the hydrosol of the surface-treated rutile-type titanium oxide to solvent substitution with a water-insoluble solvent to prepare an organosuspension, and (4) a step of adding a basic additive and a silane coupling agent to the organosuspension to form an organosol.

As described later, a specific method (technique) used in each of the steps of the production method according to the present invention is a general one or a publicly known one, but the order thereof is important in the production method according to the present invention.

### Step of Producing Hydrosol of Rutile-Type Titanium Oxide

The method for producing a hydrosol of rutile-type titanium oxide is not particularly limited, and a publicly known method can be employed. Typical examples thereof include a method including dissolving a water-soluble tin compound (rutile-forming agent) in water and hydrolyzing the water-soluble tin compound by heating to precipitate a part of the water-soluble tin compound, subsequently adding a water-soluble titanium compound and hydrolyzing the water-soluble titanium compound, removing salts, and subsequently blending a strong acid or a strong alkali to cause deflocculation, and a method including dissolving a water-soluble tin compound and a water-soluble titanium compound in water and hydrolyzing the compounds, removing salts, and subsequently blending a strong acid or a strong alkali to cause deflocculation.

Examples of the water-soluble titanium compound include titanyl sulfate, titanium tetrachloride, and titanium sulfate, and examples of the water-soluble tin compound (rutile-forming agent) include tin sulfate, tin chloride, and tin nitrate. Examples of the strong acid include monovalent acids such as hydrochloric acid and nitric acid, and organic acids such as oxalic acid, and examples of the strong alkali include sodium hydroxide and amine-based materials such as tert-butylamine, isopropylamine, diethylamine, and triethanolamine.

The amount of water-soluble tin compound added is required to be 50 mass% or less in terms of SnO₂ relative to rutile-type titanium oxide (TiO₂), and is, in particular, preferably 1 to 25 mass% in terms of SnO₂ relative to rutile-type titanium oxide (TiO₂) . On the other hand, the amount of strong acid or strong alkali blended is not particularly limited as long as solation occurs.

### Step of Treating Surface of Rutile-Type Titanium Oxide with Hydrous Oxide of at Least One Metal Species Selected from Zr, Ce, Sn, and Fe

Regarding the step of treating a surface of rutile-type titanium oxide with a hydrous oxide of at least one metal species selected from Zr, Ce, Sn, and Fe, the method itself is also not particularly limited, and a publicly known method can be employed. Typical examples thereof include a method including adding a water-soluble compound of at least one metal species selected from Zr, Ce, Sn, and Fe to a hydrosol of rutile-type titanium oxide, and subsequently adjusting the pH with an acid or an alkali, and a method including adding an aqueous solution of a water-soluble compound of at least one metal species selected from Zr, Ce, Sn, and Fe to a hydrosol of rutile-type titanium oxide while adjusting the pH with an acid or an alkali.

The amount of water-soluble compound of at least one metal species selected from Zr, Ce, Sn, and Fe added is such an amount that the resultant ratio of the metal species becomes 20 to 50 mass% in x-ray photoelectron spectroscopy. The water-soluble compound is preferably blended in an amount of 1 to 50 mass% (more preferably 8 to 33 mass%) relative to rutile-type titanium oxide (TiO₂).

### Step of Subjecting Hydrosol of Surface-Treated Rutile-Type Titanium Oxide to Solvent Substitution with Water-Insoluble Solvent to Prepare Organosuspension

Regarding the step of subjecting the hydrosol of the surface-treated rutile-type titanium oxide to solvent substitution with a water-insoluble solvent to prepare an organosol (solvent substitution step), the method itself is also not particularly limited, and a publicly known method can be employed. A typical example thereof is a method in which a water-soluble solvent such as an alcohol, e.g., methanol, ethanol, or isopropanol, acetone, or propylene glycol monomethyl ether (PGME) is used to make the hydrosol (suspension) of the surface-treated rutile-type titanium oxide compatible with a water-insoluble solvent, and solvent substitution is then performed by a technique such as ultrafiltration, dialysis, or evaporation. Subsequently, concentration can be performed to thereby increase the concentration of the surface-treated rutile-type titanium oxide to a predetermined concentration.

### Step of Adding Basic Additive and Silane Coupling Agent to Organosuspension to Form Organosol

Regarding the step of adding a basic additive and a silane coupling agent to the organosuspension, the method itself is also not particularly limited, and the basic additive and the silane coupling agent may be added at the same time or may be separately added. These may be added at one time or may be gradually added.

Regarding the step of forming an organosol, the method itself is also not particularly limited, and a publicly known method can be employed. In general, the formation is performed with a dispersion instrument such as a bead mill, a disper, or a homogenizer such that aggregation or insufficient dispersion (insufficient deflocculation) does not occur.

### Hydrothermal Treatment Step

The method for producing a rutile-type titanium oxide organosol according to the present invention may further include a step of subjecting colloidal particles to hydrothermal treatment in a high-temperature high-pressure container. Through this step, the refractive index of rutile-type titanium oxide can be further enhanced.

The timing at which the hydrothermal treatment step is performed may be after any of the step of producing rutile-type titanium oxide, the step of treating the surface of rutile-type titanium oxide, the step of subjecting a hydrosol of rutile-type titanium oxide to solvent substitution with a water-insoluble solvent to prepare an organosuspension, and the step of adding a basic additive and a silane coupling agent to the organosuspension to form an organosol but is preferably after the step of producing rutile-type titanium oxide from the viewpoint of promoting crystallization of titania particles.

The hydrothermal treatment step is preferably performed at a temperature of 100° C. to 250° C. (more preferably 150° C. to 200° C.) and a pressure of 0.1 to 4 MPa (more preferably 0.5 to 2 MPa) for a treatment time of 5 to 72 hours (more preferably 5 to 24 hours).

### EXAMPLES

Next, rutile-type titanium oxide organosols according to the present invention will be described in detail on the basis of Examples and Comparative Examples. The present invention is not limited to the following Examples.

### Example 1

### Step A: Preparation of Hydrosol of Rutile-Type Titanium Oxide

First, 303 g of titanyl sulfate (100 g in terms of TiO₂) and 6.2 g of tin sulfate (3.0 g in terms of SnO₂, 3 mass% relative to TiO₂) were dissolved in 1690.8 g of water, and the pH was then adjusted to 7.0 with a 10% aqueous sodium hydroxide solution.

Subsequently, a precipitated mixture of titanium hydrous oxide and tin hydrous oxide was separated by filtration and washed with water to prepare a cake having a solid content of 12.0%.

Lastly, 278 g of concentrated hydrochloric acid and 863.7 g of water were gradually added to 858.3 g of the cake, and the cake was deflocculated under stirring to prepare 2,000 g of a rutile-type titanium oxide hydrosol (TiO₂ concentration: 5 mass%).

### Step B: Surface Treatment of Rutile-Type Titanium Oxide Particles with Hydrous Oxide of Metal Species

To the rutile-type titanium oxide hydrosol obtained in step A, 26.1 g of zirconium oxychloride octahydrate (10 g in terms of ZrO₂, 10 mass% relative to TiO₂) was added as a raw material of a hydrous oxide of a metal species.

Subsequently, the pH was adjusted to 6.0 with a 10% aqueous sodium hydroxide solution, the precipitate was separated by filtration and washed with water, and water was then added to prepare a 1,000 g of a suspension of rutile-type titanium oxide particles that had been surface-treated with a hydrous oxide of zirconium (TiO₂ concentration: 10 mass%).

### Step C: Preparation of Rutile-Type Titanium Oxide Organosol

To the suspension obtained in step B, 1,000 g of isopropanol was added to make the resulting mixture compatible with 1,000 g of propylene glycol monomethyl ether acetate. Subsequently, ultrafiltration was conducted while adding propylene glycol monomethyl ether acetate stepwise to perform solvent substitution such that the total amount became 383 g (calculated value of the inorganic oxide content ratio (when calculated as the oxide) became 30 mass%).

Subsequently, 20 g of 3-acryloxypropyltrimethoxysilane (20 mass% relative to TiO₂) acting as a silane coupling agent and 5 g of tert-butylamine (5 mass% relative to TiO₂) acting as a basic additive were added, and dispersion treatment was performed in a bead mill to prepare a rutile-type titanium oxide organosol of Example 1.

### Example 2

A rutile-type titanium oxide organosol of Example 2 was prepared as in Example 1 except that, in step C, the amount of 3-acryloxypropyltrimethoxysilane added was changed to 35 g (35 mass% relative to TiO₂).

### Example 3

A rutile-type titanium oxide organosol of Example 3 was prepared as in Example 1 except that, in step B, the amount of zirconium oxychloride octahydrate added was changed to 130.5 g (50 g in terms of ZrO₂, 50 mass% relative to TiO₂).

### Example 4

A rutile-type titanium oxide organosol of Example 4 was prepared as in Example 1 except that, in step B, the raw material of a hydrous oxide of a metal species was changed from zirconium oxychloride octahydrate to 17.3 g of tin chloride (10 g in terms of SnO₂, 10 mass% relative to TiO₂).

### Example 5

A rutile-type titanium oxide organosol of Example 5 was prepared as in Example 4 except that, in step C, the amount of tert-butylamine added was changed to 10 g (10 mass% relative to TiO₂).

### Example 6

A rutile-type titanium oxide organosol of Example 6 was prepared as in Example 4 except that, in step C, the basic additive was changed from tert-butylamine to an amine-based dispersant (DISPERBYK-108: manufactured by BYK Japan KK, 5 mass% relative to TiO₂).

### Example 7

A rutile-type titanium oxide organosol of Example 7 was prepared as in Example 4 except that, in step C, the silane coupling agent was changed from 3-acryloxypropyltrimethoxysilane to 3-methacryloxypropyltrimethoxysilane.

### Example 8

A rutile-type titanium oxide organosol of Example 8 was prepared as in Example 7 except that, in step C, the solvent substitution was performed with propylene glycol monomethyl ether acetate such that the total amount became 256 g (calculated value of the inorganic oxide content ratio became 45 mass%).

### Example 9

A rutile-type titanium oxide organosol of Example 9 was prepared as in Example 7 except that, in step C, the water-insoluble solvent was changed from propylene glycol monomethyl ether acetate to methyl ethyl ketone.

### Example 10

A rutile-type titanium oxide organosol of Example 10 was prepared as in Example 7 except that, in step C, the water-insoluble solvent was changed from propylene glycol monomethyl ether acetate to ethyl acetate.

### Example 11

A rutile-type titanium oxide organosol of Example 11 was prepared as in Example 7 except that, in step C, the water-insoluble solvent was changed from propylene glycol monomethyl ether acetate to methyl isobutyl ketone.

### Example 12

A rutile-type titanium oxide organosol of Example 12 was prepared as in Example 7 except that, in step C, the water-insoluble solvent was changed from propylene glycol monomethyl ether acetate to methyl amyl ketone.

### Example 13

A rutile-type titanium oxide organosol of Example 13 was prepared as in Example 7 except that, in step C, the water-insoluble solvent was changed from propylene glycol monomethyl ether acetate to toluene.

### Example 14

A rutile-type titanium oxide organosol of Example 14 was prepared as in Example 7 except that, in step A, the obtained rutile-type titanium oxide hydrosol was subjected to hydrothermal treatment (temperature: 200° C., treatment time: 10 hours, pressure: 1.6 MPa, Device name: Highpressure microreactor MMJ-200, manufactured by OM Lab-Tech Co., Ltd.).

### Comparative Example 1

A rutile-type titanium oxide organosol of Comparative Example 1 was prepared as in Example 1 except that, in step B, zirconium oxychloride octahydrate was not added.

### Comparative Example 2

A rutile-type titanium oxide organosol of Comparative Example 2 was prepared as in Example 4 except that, in step B, the amount of tin chloride added was changed to 206 g (60 g in terms of SnO₂, 60 mass% relative to TiO₂).

### Comparative Example 3

A production of a rutile-type titanium oxide organosol of Comparative Example 3 was attempted as in Example 1 except that, in step C, neither the basic additive nor the silane coupling agent was added, but 50 g of an organic dispersant (DISPEFBYK-111: manufactured by BYK Japan KK, 50 mass% relative to TiO₂) was added. However, gelation occurred during the production, and the rutile-type titanium oxide organosol could not be prepared.

### Comparative Example 4

A production of a rutile-type titanium oxide organosol of Comparative Example 4 was attempted as in Example 4 except that, in step C, tert-butylamine was not added. However, solation could not be caused, and the rutile-type titanium oxide organosol could not be prepared.

### Comparative Example 5

A rutile-type titanium oxide organosol was prepared as in Example 4 except that, in step A, the amount of tin sulfate added was changed to 155 g (75 g in terms of SnO₂, 75 mass% relative to TiO₂).

### Measurement of Physical Property Values and Evaluation of Viscosity Stability over Time and Haze Value

For the rutile-type titanium oxide organosols of Examples 1 to 14 and Comparative Examples 1 to 5, the measurement of physical property values and the evaluation of viscosity stability over time and haze value were conducted. Methods for measuring the physical property values are described below, and the results are shown in Table 1.

Dry solids content: A certain amount (W) of about 1 g of a rutile-type titanium oxide organosol was weighed in an evaporating dish and dried by heating at 150° C. for two hours, a dry mass (w) was measured, and the dry solids content was calculated on the basis of the following formula.

$$\text{Dry} \text{solids} \text{content} \text{(\%)} \text{=} \text{(w/W)} \text{×} \text{100}$$

Ignition residue (when calculated as the oxide): A certain amount (W) of about 1 g of a rutile-type titanium oxide organosol was weighed in an evaporating dish, a mass (h) of the residue after heating at 925° C. for two hours was measured, and the ignition residue was calculated on the basis of the following formula.

$$\text{Ignition} \text{residue} \text{(\%)} \text{=} \text{(h/W)} \text{×} \text{100}$$

Ratio of metal species at colloidal particle surface: The measurement was conducted with an x-ray photoelectron spectrometer (ESCA-3400: manufactured by Shimadzu Corporation).

Average particle diameter: Each of the rutile-type titanium oxide organosols of Examples 1 to 14 and Comparative Examples 1 to 5 was diluted with the water-insoluble solvent used in the preparation of the rutile-type titanium oxide organosol to a solid content of 5 mass%. The diluted solution was measured with a zeta-potential/particle size measurement system (ELSZ-1000: manufactured by Otsuka Electronics Co., Ltd.), and the value of D50 was determined as the average particle diameter.

Viscosity: A viscosity at 25° C. was measured using a rheometer (HAAKE MARS 60: manufactured by Thermo Fisher Scientific Inc., 6 cm cone plate, rotational speed 60 rpm).

Viscosity stability over time: When a rutile-type titanium oxide organosol was placed in a hermetically sealed container and left to stand in a thermostatic chamber at 40° C. for two weeks, a viscosity at 25° C. was measured using a rheometer (HAAKE MARS 60: manufactured by Thermo Fisher Scientific Inc., 6 cm cone plate, rotational speed 60 rpm).

Haze value: Each of the rutile-type titanium oxide organosols of Examples 1 to 14 and Comparative Examples 1 to 5 was diluted with the water-insoluble solvent used in the preparation of the rutile-type titanium oxide organosol to a solid content of 5 mass%, the diluted solution was placed in a quartz cell with an optical path length of 10 mm, and a haze value was measured with a haze meter (Haze meter: NDH-4000, manufactured by Nippon Denshoku Industries Co., Ltd.).

Table 1

| | Organosol | | | | | | | | | | Measurement and evaluation | | | | | | | | |
|---|---|---|---|---|---|---|---|---|---|---|---|---|---|---|---|---|---|---|---|
| | Colloidal particles | | | | | Water-insoluble solvent | Basic additive | | Silane coupling agent | | Inorganic components in organosol | | Ratio of metal species at colloidal particle surface | | | Average particle diameter (nm) | Viscosity (mPa·s) | | Haze value (%) |
| | Rutile-type titanium oxide | | Metal species | | Silane coupling agent | | | | | | Dry solids content (mass%) | Ignition residue (when calculated as oxide) (mass%) | | | | | Initial | After 40° C. × 2 weeks | |
| | When calculated as TiO₂ (mass%) | When calculated as SnO₂ (mass%) | When calculated as ZrO₂ (mass%) | When calculated as SnO₂ (mass%) | When calculated as SiO₂ (mass%) | | Type | Content (mass%, relative to TiO₂) | Type | Content (mass%, relative to TiO₂) | | | Si (mass%) | Ti (mass%) | Metal (mass%)species | | | | |
| Example 1 | 87.0 | 26 | 8.7 | - | 1.7 | Propylene glycol monomethyl ether acetate | tert-Butylamine | 5 | 3-Acryloxypropyl trimethoxysilane | 20 | 35.2 | 30.1 | 9 | 57 | 34 | 29 | 10 | 12 | 19 |
| Example 2 | 85.8 | 2.6 | 9.8 | - | 30 | Propylene glycol monomethyl ether acetate | tert-Butylamine | 5 | 3-Acryloxypropyl trimethoxysilane | 35 | 35.4 | 30.4 | 18 | 50 | 32 | 26 | 7 | 11 | 17 |
| Example 3 | 64.5 | 1.9 | 32.3 | - | 13 | Propylene glycol monomethyl ether acetate | tert-Butylamine | 5 | 3-Acryloxypropyl trimethoxxysilane | 20 | 35.3 | 30.2 | 35 | 35 | 30 | 26 | 8 | 10 | 18 |
| Example 4 | 87.0 | 2.6 | - | 8.7 | 1.7 | Propylene glycol monomethyl ether acetate | tert-Butylamine | 5 | 3-Acryloxypropyl trimethoxysilane | 20 | 35.2 | 30.2 | 9 | 58 | 33 | 25 | 8 | 7 | 18 |
| Exanple 5 | 87.0 | 2.6 | - | 8.7 | 1.7 | Propylene glycol monomethyl ether acetate | tert-Butylamine | 10 | 3-Acryloxypropyl trimethoxysilane | 20 | 35.1 | 29.8 | 9 | 59 | 32 | 20 | 6 | 6 | 14 |
| Example 6 | 87.0 | 2.6 | - | 8.7 | 1.7 | Propylene glycol monomethyl ether acetate | DISPERBYK-108 | 5 | 3-Acryloxypropyl trimethoxysilane | 20 | 37.6 | 29.7 | 8 | 67 | 35 | 23 | 7 | 8 | 16 |
| Example 7 | 87.0 | 2.6 | - | 8.7 | 1.7 | Propylene glycol monomethyl ether acetate | tert-Butylamine | 5 | 3-Methacryloxypropyl trimethoxysilane | 20 | 35.6 | 29.8 | 10 | 58 | 32 | 21 | 6 | 7 | 13 |
| Example 8 | 87.0 | 2.6 | - | 8.7 | 1.7 | Propylene glycol monomethyl ether acetate | tert-Butylamine | 5 | 3-Methacryloxypropyl trimethoxysilane | 20 | 50.2 | 44.8 | 10 | 57 | 33 | 22 | 8 | 10 | 14 |
| Example 9 | 87.0 | 26 | - | 8.7 | 1.7 | Methyl ethyl ketone | tert-Butylamine | 5 | 3-Methacryloxypropyl trimethoxysilane | 20 | 34.8 | 29.6 | 9 | 59 | 32 | 20 | 6 | 7 | 14 |
| Example 10 | 87.0 | 2.6 | - | 8.7 | 1.7 | Ethyl acetate | tert-Butylamine | 5 | 3-Methacryloxypropyl trimethoxysilane | 20 | 34.6 | 30.2 | 10 | 56 | 34 | 21 | 6 | 6 | 16 |
| Example 11 | 87.0 | 2.6 | - | 8.7 | 17 | Methyl isobutyl ketone | tert-Butylamine | 5 | 3-Methacryloxypropyl trimethoxysilane | 20 | 34.5 | 29.9 | 8 | 57 | 35 | 22 | 7 | 8 | 15 |
| Example12 | 87.0 | 2.6 | - | 8.7 | 1.7 | Methyl arnyl ketone | tert-Butytamine | 5 | 3-Methacryloxypropyl trimethoxysilane | 20 | 34.8 | 29.7 | 9 | 58 | 33 | 23 | 5 | 8 | 14 |
| Example 13 | 87.0 | 2.6 | - | 9.7 | 1.7 | Toluene | tert-Butylamine | 5 | 3-Methacryloxypropyl trimethoxysilane | 20 | 34.2 | 30.1 | 9 | 54 | 37 | 26 | 8 | 9 | 18 |
| Example 14 | 87.0 | 2.6 | - | 8.7 | 1.7 | Propylene glycol monomethyl ether acetate | tert-Butylamine | 5 | 3-Methacryloxypropyl trimethoxysilane | 20 | 35.3 | 303 | 9 | 56 | 35 | 31 | 11 | 13 | 19 |
| Comparative Example 1 | 95.2 | 2.9 | - | - | 1.9 | Propylene glycol monomethyl ether acetate | tert-Butylamine | 5 | 3-Acryloxypropyl trimethoxysilane | 20 | 35.4 | 29.8 | 8 | 87 | 5 | 48 | 25 | 250 | 39 |
| Comparatie Example 2 | 60.6 | 1.8 | - | 36.4 | 1.2 | Propylene glycol monomethyl ether acetate | tert-Butylamine | 5 | 3-Acryloxypropyl trimethoxysilane | 20 | 35.2 | 29.9 | 30 | 5 | 65 | 59 | 21 | 320 | 35 |
| Comparative Example 3 | 88.5 | 2.7 | 8.8 | - | - | Propylene glycol monomethyl ether acetate | - | - | DISPERBYK-111 | 50 | 35.1 | 25 | 0 | 87 | 33 | 44 | Gelation | - | 33 |
| Comparative Example 4 | 87.0 | 2.6 | - | 8.7 | 1.7 | Propylene glycol monomethyl ether acetate | - | - | 3-Acryloxypropyl trimethoxysilane | 20 | 35.1 | 30.1 | 9 | 56 | 33 | 185 | - | - | Solation did not occur |
| Comparative Example 5 | 535 | 40.1 | - | 5.3 | 1.1 | Propylene glycol monomethyl ether acetate | tert-Butylamine | 5 | 3-Acryloxypropyl trimethoxysilane | 20 | 35.1 | 30.1 | 11 | 44 | 45 | 48 | 25 | 500 | 45 |

According to the results, as shown in Table 1, the rutile-type titanium oxide organosols obtained in Examples 1 to 14 are organosols each of which had a low initial viscosity, a good viscosity stability over time, and a high transparency.

In contrast, the rutile-type titanium oxide organosol of Comparative Example 1 was an unstable rutile-type titanium oxide organosol which had a high initial viscosity and whose viscosity also increased significantly over time because the ratio of the metal species (Sn) was low, although Sn derived from tin sulfate (rutile-forming agent) was present. Furthermore, deflocculation was not sufficiently caused, and therefore, the rutile-type titanium oxide organosol had a large average particle diameter of the colloidal particles, a high haze value, and had a poor transparency.

The rutile-type titanium oxide organosol of Comparative Example 2 was an unstable rutile-type titanium oxide organosol which had a high initial viscosity and whose viscosity also increased significantly over time because of the excessively high surface ratio of the metal species. Furthermore, deflocculation was not sufficiently caused, and therefore, the rutile-type titanium oxide organosol had a large average particle diameter of the colloidal particles, a high haze value, and had a poor transparency.

Regarding the rutile-type titanium oxide organosol of Comparative Example 3, deflocculation itself in the water-insoluble solvent could be performed because the dispersant (DISPERBYK-111) was used in a large amount; however, gelation occurred during the preparation because neither the silane coupling agent nor the basic additive was used.

Regarding the rutile-type titanium oxide organosol of Comparative Example 4, deflocculation (solation) itself in the water-insoluble solvent could not be performed because no basic additive was used, although the silane coupling agent was used.

The rutile-type titanium oxide organosol of Comparative Example 5 was a rutile-type titanium oxide organosol having a high haze value and a significantly poor transparency because of the low Ti ratio in the colloidal particles. In addition, the organosol was an unstable rutile-type titanium oxide organosol which had a high initial viscosity and whose viscosity also increased significantly over time.

### Preparation of High Refractive Index Coating-Forming Composition: Examples 15 to 28 and Comparative Examples 6 to 10

High refractive index coating-forming compositions were prepared using the rutile-type titanium oxide organosols of Examples 1 to 14 and Comparative Examples 1 to 5.

First, 16.7 g of a UV-curable resin (trade name: SHIKOH UV-7605B, manufactured by Mitsubishi Chemical Corporation, URL: https://www.m-chemical.co.jp/products/departments/mcc/coating-mat/tech/1205785_9232.html, polyfunctional urethane acrylate resin, pencil hardness 3 H to 4 H) was dissolved in 9.0 g of the water-insoluble solvent used in the preparation of each of the rutile-type titanium oxide organosols of Examples and Comparative Examples (resin A).

Subsequently, 0.3 g of 1-hydroxycyclohexylphenyl ketone and 0.3 g of bis(2,4,6-trimethylbenzoyl)-phenylphosphine oxide acting as polymerization initiators were dissolved in 7.0 g of the water-insoluble solvent used in the preparation of each of the rutile-type titanium oxide organosols of Examples and Comparative Examples (polymerization initiator A).

Subsequently, 25.7 g of the resin A and 7.6 g of the polymerization initiator A were mixed to prepare a binder.

Lastly, 100 g of each of the rutile-type titanium oxide organosols of Examples 1 to 14 and Comparative Example 1 to 5, 50 g of the water-insoluble solvent used in the preparation of each of the rutile-type titanium oxide organosols of Examples and Comparative Examples, and 33.3 g of the binder were mixed to prepare high refractive index coating-forming compositions of Examples 15 to 28 and Comparative Examples 6 to 10.

A high refractive index coating-forming composition of Example 29 was prepared as in Example 21 except that the UV-curable resin was changed to a phenoxyethyl (meth)acrylate (pencil hardness 2 H).

A high refractive index coating-forming composition of Comparative Example 11 was prepared as in Comparative Example 8 except that the UV-curable resin was changed to a phenoxyethyl (meth)acrylate (pencil hardness 2 H).

### Evaluation of Viscosity and Haze Value

Regarding the high refractive index coating-forming compositions of Examples 15 to 29 and Comparative Examples 6 to 11, Table 2 shows the viscosity at 25° C. and the haze value as measured at an optical path length of 10 mm after dilution with the water-insoluble solvent used in the preparation of each of the rutile-type titanium oxide organosols of Examples and Comparative Examples to a solid content of 5 mass%.

Table 2

| | Haze value (%) | viscosity (mPa ·s) |
|---|---|---|
| Example 15 | 28 | 19 |
| Example 16 | 26 | 19 |
| Example 17 | 26 | 17 |
| Example 18 | 24 | 19 |
| Example 19 | 19 | 15 |
| Example 20 | 19 | 14 |
| Example 21 | 18 | 14 |
| Example 22 | 20 | 13 |
| Example 23 | 19 | 14 |
| Example 24 | 21 | 15 |
| Example 25 | 22 | 16 |
| Example 26 | 22 | 16 |
| Example 27 | 23 | 16 |
| Example 28 | 28 | 19 |
| Example 29 | 20 | 8 |
| Comparative Example 6 | 67 | 31 |
| Comparative Example 7 | 59 | 29 |
| Comparative Example 8 | 45 | 88 |
| Comparative Example 9 | 92 | 23 |
| Comparative Example 10 | 60 | 23 |
| Comparative Example 11 | 42 | 53 |

According to the results, as shown in Table 2, the high refractive index coating-forming compositions obtained in Examples 15 to 29 were high refractive index coating-forming compositions having a low initial viscosity and a high transparency.

In contrast, the high refractive index coating-forming compositions of Comparative Examples 6 and 7 were high refractive index coating-forming compositions having both a poor transparency and a poor viscosity because the ratio of the metal species was low or the surface ratio of the metal species was excessively high.

The high refractive index coating-forming compositions of Comparative Examples 8 and 11 were high refractive index coating-forming compositions having a poor transparency and a significantly poor viscosity because the gelated rutile-type titanium oxide organosol was used.

The high refractive index coating-forming composition of Comparative Example 9 was a high refractive index coating-forming composition having a significantly poor transparency because of the rutile-type titanium oxide organosol that could not solate was used.

The high refractive index coating-forming composition of Comparative Example 10 was a high refractive index coating-forming composition having both a poor transparency and a poor viscosity because the rutile-type titanium oxide organosol having a low Ti ratio in the colloidal particles was used.

### Preparation of Optical Element: Examples 30 to 44 and Comparative Examples 12 to 17

Optical elements were prepared using the high refractive index coating-forming compositions of Examples 15 to 29 and Comparative Examples 6 to 11.

First, each of the high refractive index coating-forming compositions of Examples 15 to 29 and Comparative Examples 6 to 11 was spin-coated onto a micro slide glass plate (manufactured by Matsunami Glass Ind., Ltd.) with a size of 70 mm × 55 mm × 1.3 mm in an environment at a temperature of 25° C. and a humidity of 50% under a condition of 500 rpm × 3 seconds.

Subsequently, the glass plate was dried at 80° C. for 30 minutes and then irradiated with ultraviolet rays at 580 mJ/cm² to prepare optical elements of Examples 30 to 44 and Comparative Examples 12 to 17 in which a coating layer with a thickness of 2 µm was formed as a surface layer.

### Evaluation of Haze Value, Refractive Index, and Pencil Hardness

For the optical elements of Examples 30 to 44 and Comparative Examples 12 to 17, the haze value, the refractive index, and the pencil hardness were evaluated.

Specifically, the haze value was evaluated by measuring the glass plate coated with the high refractive index coating-forming composition using a haze meter (Haze meter: NDH-4000, manufactured by Nippon Denshoku Industries Co., Ltd.).

The refractive index was evaluated by measuring the glass plate coated with the high refractive index coating-forming composition using an ellipsometer (DVA-FL3G: manufactured by Mizojiri Optical Co., Ltd., wavelength 633 nm).

The pencil hardness was evaluated in accordance with JISK5600-5-4. Specifically, scratching was performed with an electrical pencil scratch hardness tester (No. 553-M: manufactured by Yasuda Seiki Seisakusho, Ltd.) at a load of 9.8 N using pencils of H to 9 H for the test. Subsequently, among the pencil hardnesses at which the number of portions where scratches were visually observed was 0 to 2, the highest pencil hardness was used as the evaluation result.

Table 3

| | Haze value (%) | Refractive index | Pencil hardness |
|---|---|---|---|
| Example 30 | 0.9 | 1.73 | 9 H or more |
| Example 31 | 0.8 | 1.72 | 9 H or more |
| Example 32 | 0.8 | 1.72 | 9 H or more |
| Example 33 | 0.7 | 1.74 | 9 H or more |
| Example 34 | 0.5 | 1.70 | 9 H or more |
| Example 35 | 0.5 | 1.74 | 9 H or more |
| Example 36 | 0.5 | 1.79 | 9 H or more |
| Example 37 | 0.5 | 1.85 | 9 H or more |
| Example 38 | 0.6 | 1.71 | 9 H or more |
| Example 39 | 0.7 | 1.73 | 9 H or more |
| Example 40 | 0.8 | 1.74 | 9 H or more |
| Example 41 | 0.7 | 1.73 | 9 H or more |
| Example 42 | 0.8 | 1.74 | 9 H or more |
| Example 43 | 0.9 | 1.91 | 9 H or more |
| Example 44 | 0.9 | 1.81 | 6 H |
| Comparative Example 12 | 8 | 1.65 | 9 H or more |
| Comparative Example 13 | 6 | 1.60 | 9 H or more |
| Comparative Example 14 | 2 | 1.68 | 4 H |
| Comparative Example 15 | 23 | Could not be measured | 9 H or more |
| Comparative Example 16 | 7 | 1.60 | 9 H or more |
| Comparative Example 17 | 3 | 1.69 | 2 H |

According to the results, as shown in Table 3, the optical elements obtained in Examples 30 to 44 were optical elements including a coating layer having a high transparency and a high refractive index. In particular, the optical element obtained in Example 43 was an optical element including a coating layer having a higher refractive index because the high refractive index coating-forming composition containing the rutile-type titanium oxide organosol that had been subjected to hydrothermal treatment was used.

The coating layer was an excellent coating layer having a pencil hardness higher than the pencil hardness (4 H or 2 H) of the UV-curable resin itself because the silane coupling agent present on the surfaces of the particles of the rutile-type titanium oxide organosol polymerizes with the UV-curable resin to form a strong network. In particular, even when the UV-curable resin was a monofunctional crosslinkable monomer, the coating layer exhibited an excellent pencil hardness of 6 H.

In contrast, in the optical elements of Comparative Examples 12, 13, 14, 16, and 17, the aggregation of colloidal particles was observed, the coating film had a high haze value, and thus a significant improvement in the refractive index was not observed.

Furthermore, the optical elements of Comparative Examples 14 and 17 were optical elements prepared by using a rutile-type titanium oxide organosol using an organic dispersant instead of the silane coupling agent. Thus, the results showed that polymerization with the UV-curable resin did not occur and the pencil hardness of the coating layer did not change from the pencil hardness (4 H or 2 H) of the UV-curable resin itself.

The optical element of Comparative Example 15 was an optical element including a coating layer whose refractive index could not be measured because smoothness of the film was not obtained.

### Industrial Applicability

The rutile-type titanium oxide organosol according to the present invention can be used for, for example, antireflection films for optical components, thin films for image pickup devices, and hard coat films.

1. A rutile-type titanium oxide organosol comprising:
rutile-type titanium oxide particles that have been surface-treated with a hydrous oxide of at least one metal species selected from Zr, Ce, Sn, and Fe;
a silane coupling agent;
a basic additive acting as a deflocculant; and
a water-insoluble solvent,
wherein a ratio of Ti contained in colloidal particles in the rutile-type titanium oxide organosol is at least 60 mass% when calculated as the oxide, and
a ratio of the metal species at surfaces of the colloidal particles derived from x-ray photoelectron spectroscopy is 20 to 50 mass%.

2. The rutile-type titanium oxide organosol according to claim 1, wherein a content ratio of the colloidal particles is at least 28 mass% when calculated as the oxide, and a viscosity is 15 mPa·s or less.

3. The rutile-type titanium oxide organosol according to claim 1, having a haze value of 20% or less measured at an optical path length of 10 mm when being diluted with the water-insoluble solvent to a solid content of 5% by mass.

4. The rutile-type titanium oxide organosol according to claim 1, wherein the basic additive is
a water-soluble amine.

5. A high refractive index coating-forming composition comprising the rutile-type titanium oxide organosol according to claim 1.

6. An optical element comprising a coating layer formed from the high refractive index coating-forming composition according to claim 5.

7. The optical element according to claim 6, wherein the coating layer has a pencil hardness of at least 6 H.

8. A method for producing a rutile-type titanium oxide organosol, the method comprising:
a step of producing a hydrosol of rutile-type titanium oxide;
a step of treating a surface of the rutile-type titanium oxide with a hydrous oxide of at least one metal species selected from Zr, Ce, Sn, and Fe;
a step of subjecting the hydrosol of the surface-treated rutile-type titanium oxide to solvent substitution with a water-insoluble solvent to prepare an organosuspension; and
a step of adding a basic additive and a silane coupling agent to the organosuspension to form an organosol.

9. The method for producing a rutile-type titanium oxide organosol according to claim 8, further comprising a hydrothermal treatment step.
